(19) United States
(12) Patent Application Publication
(10) Pub. No.: US 2022/0376870 A1
(43) Pub. Date: Nov. 24, 2022

(54) DEMODULATOR IMPLEMENTATION THAT SUPPORTS BOTH NON-VLSNR AND VLSNR DOWNLINK FRAMES PRESENT IN A SINGLE STREAM

(71) Applicant: HUGHES NETWORK SYSTEMS, LLC, Germantown, MD (US)

(72) Inventors: Brandon LASHER, Germantown, MD (US); Bala SUBRAMANIAM, Germantown, MD (US); Seokho KIM, Germantown, MD (US); Sri BHAT, Germantown, MD (US); Tejo Bhavani Shankar POTHURAJU, Germantown, MD (US)

(73) Assignee: HUGHES NETWORK SYSTEMS, LLC, Germantown, MD (US)

(21) Appl. No.: 17/566,544

(22) Filed: Dec. 30, 2021

Related U.S. Application Data
(60) Provisional application No. 63/190,532, filed on May 19, 2021.

(51) Int. Cl. H04L 5/00; H04L 69/22

(52) U.S. Cl. CPC H04L 5/0053; H04L 5/006; H04L 5/0046; H04L 69/22

(57) ABSTRACT

An apparatus and method for detecting multiple types of data frames within a single data stream. The data stream is examined to determine if a data frame contained therein is of a first type or a second type. The data frame is processed based on its determined type. The type of data frame is selected from a predetermined set of data frame types. Additionally, the determination is made based on detection of a first portion of the data frame or a second portion of the data frame.

### CROSS-REFERENCE TO RELATED APPLICATION

The present application claims priority to U.S. Provisional Patent Application No. 63/190,532 filed May 19, 2021, and entitled “DEMODULATOR IMPLEMENTATION THAT SUPPORTS BOTH NON-VLSNR AND VLSNR DOWNLINK FRAMES PRESENT IN A SINGLE STREAM”, the entire disclosure of which is incorporated herein by reference.

### BACKGROUND INFORMATION

Satellite communication systems are widely used as a platform for providing communication services. Consumers are able to utilize such services as an alternative, or in addition, to conventional terrestrial communication services. Satellite communication systems can be used to provide voice and data communication, video transmission, broadcasting, etc. In areas that are unable to support conventional communication services (e.g., rural, undeveloped, waterways, etc.), satellite communication systems may be the only way in which consumers can access these services.

Various standards have been developed to define a framework for broadcasting digital video using, for example, a satellite communication system. These standards include, without limitation, digital video broadcasting (DVB), DVB-S2, DVB-S2X, etc. These standards define categories such as data framing structures, channel coding parameters, modulation parameters, etc. that can be used to encode and transmit the digital video signals. In addition to the DVB standards, data compression techniques such as MPEG (Moving Picture Experts Group), MPEG-2, MPEG-4, etc. can be applied to reduce the size of broadcast signals.

Broadcasting services that employ DVB-S2X standards can include data streams that contain both very low signal-to-noise ratio (VLSNR) frame headers having 900 symbols, as well as conventional physical layer header (PLH) frames having 90 or 180 symbols. The large 900-symbol VLSNR header is used to improve detection when the operating signal-to-noise ratio (SNR) is less than −2.5 decibel (dB). A carrier can typically be configured to operate exclusively in either VLSNR mode or in regular, often referred to as non-VLSNR, mode. In VLSNR mode, for example, a 900-symbol search is continuously performed to look for VLSNR frames. In regular mode, the carrier is set up to detect and decode only the PLH in order to look for regular or non-VLSNR frames.

When a user terminal (e.g., satellite terminal or mobile terminal) transitions from a low Es/No location that can utilize VLSNR frames to a higher Es/No location that can utilize regular or non-VLSNR frames, or vice-versa, due to atmospheric conditions, movement of mobile terminals, etc., variations in the SNR can cause difficulties in the user terminal's ability to detect and decode the appropriate frames from the data stream. Further, in these or other situations, both regular or non-VLSNR frames and VLSNR frames may be included for reception in the same signal. Even if the user terminal includes circuitry which enables reconfiguration to detect VLSNR frames in one configuration and PLH in another configuration, such a transition would cause disruptions in frame timing synchronization resulting in unexpected and undesired loss of data.

Based on the foregoing, there is a need for an approach for detecting and decoding multiple types of frames, such as VLSNR and regular or non-VLSNR frames, in the same data stream with limited or no disruption to frame timing synchronization and overall operation of the user terminal.

### BRIEF SUMMARY

A method and apparatus are disclosed for detecting multiple types of data frames within a single data stream. According to an embodiment, the method includes receiving a data stream containing a plurality of data frames; determining if a received data frame is of a first type or a second type; and processing the received data frame based on the determined type, wherein the type of data frame is selected from a predetermined set of data frame types, and wherein the determination is based, at least in part, on detecting a first portion of the data frame or a second portion of the data frame.

According to an embodiment, the apparatus includes a tuner that receives a data stream containing a plurality of data frames; a first processing circuit coupled to the tuner, the first processing circuit processing a data frame from the plurality of data frames if the data frame is determined to be a first type of data frame; and a second processing circuit coupled to the tuner, the second processing circuit processing the data frame if the data frame is determined to be a second type of data frame, wherein the type of data frame is selected from a predetermined set of data frame types, wherein determination that the data frame is the first type is based, at least in part, on detecting a first portion of the data frame, and wherein determination that the data frame is the second type is based, at least in part, on detecting a second portion of the data frame.

The foregoing summary is only intended to provide a brief introduction to selected features that are described in greater detail below in the detailed description. As such, this summary is not intended to identify, represent, or highlight features believed to be key or essential to the claimed subject matter. Furthermore, this summary is not intended to be used as an aid in determining the scope of the claimed subject matter.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing of voice and data services, according to at least one embodiment;

FIG. 2 is a diagram of a terminal such as used in the system of FIG. 1, according to at least one embodiment;

FIG. 3 is a diagram illustrating the format of an exemplary DVB-S2X superframe;

FIG. 4 is a diagram of a decoding unit capable of processing multiple types of frames in a data stream, according to one or more embodiments;

FIG. 5 is a diagram of another decoding unit capable of processing multiple types of frames in a data stream, according to one or more embodiments;

FIG. 6 is a diagram illustrating a handshaking mechanism between the VLSNR and non-VLSNR processors in decoding unit, according to one or more embodiments;

FIG. 7 is a flowchart of a process for decoding different types of data frames in a decoding unit, according to one or more embodiments;

FIG. 8 is a flowchart of another process for decoding different types of data frames in a decoding unit, according to one or more embodiments;

FIG. 9 is a flowchart of a further process for decoding different types of data frames in a decoding unit, according to one or more embodiments;

FIG. 10 is a diagram of a computer system that can be used to implement various exemplary features and embodiments; and

FIG. 11 is a diagram of a chip set that can be used to implement various exemplary features and embodiments.

### DETAILED DESCRIPTION

An apparatus and method for detecting multiple frame types in a data stream, are described. In the following description, for purposes of explanation, numerous specific details are set forth in order to provide a thorough understanding of the disclosed embodiments. It will become apparent, however, to one skilled in the art that various embodiments can be practiced without these specific details or with an equivalent arrangement. In other instances, well-known structures and devices are shown in block diagram form in order to avoid unnecessarily obscuring the various embodiments.

The present embodiments are directed to improving the operation of terminals (or satellite terminals) or other signal receivers that are operating under varying conditions that include low and very low Es/No signals. The embodiments take advantage of the presence of signaling conditions associated with a signal transmission standard, such as DVB-S2X, to detect a type of data frame from a plurality of type of data frames in a data stream as it is being received and recover the data in that data frame. Further, the detection and recovery of information for that one type of data frame can assist in detecting and recovering other types of data frames. These and other aspects of the present embodiments described below can extend the operational range as well as reduce data loss during operation of those user terminals.

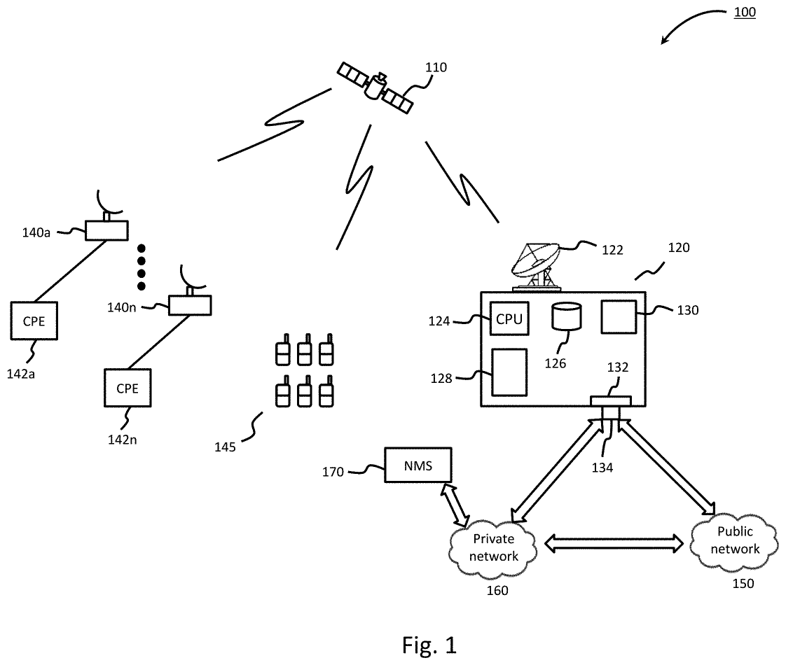

FIG. 1 illustrates a satellite communication system 100 capable of providing voice and data services. The satellite communication system 100 includes a satellite 110 that supports communications among a number of gateways 120 (only one shown) and multiple stationary satellite terminals 140a-140n. Each satellite terminal (or terminal) 140 can be configured for relaying traffic between its customer premise equipment (CPEs) 142a-142n (i.e., user equipment), a public network 150 such as the internet, and/or its private network 160. Depending on the specific embodiment, the customer premise equipment 142 can be a desktop computer, laptop, tablet, cell phone, etc. Customer premise equipment 142 can also be in the form of connected appliances that incorporate embedded circuitry for network communication can also be supported by the terminal 140. Connected appliances can include, without limitation, televisions, home assistants, thermostats, refrigerators, ovens, etc. The network of such devices is commonly referred to as the internet of things (IoT).

According to an exemplary embodiment, the terminals 140a-n can be in the form of very small aperture terminals (VSATs) that are mounted on a structure, habitat, etc. Depending on the specific application, however, the terminals 140a-n can incorporate an antenna dish of different sizes (e.g., small, medium, large, etc.). The terminals 140a-n typically remain in the same location once mounted, unless otherwise removed from the mounting. According to various embodiments, the terminals 140a-n can be mounted on mobile platforms that facilitate transportation thereof from one location to another. Such mobile platforms can include, for example, cars, buses, boats, planes, etc. The terminals 140a-n can further be in the form of transportable terminals capable of being transported from one location to another. Such transportable terminals are operational only after arriving at a particular destination, and not while being transported.

As illustrated in FIG. 1, the satellite communication system 100 can also include a plurality of mobile terminals 145 that are capable of being transported to different locations by a user. In contrast to transportable terminals, the mobile terminals 145 remain operational while users travel from one location to another. The terms user terminal, satellite terminal, terminal can be used interchangeably herein to identify any of the foregoing types. The gateway 120 can be configured to route traffic from stationary, transportable, and mobile terminals (collectively terminals 140) across the public network 150 and private network 160 as appropriate. The gateway 120 can be further configured to route traffic from the public network 150 and private network 160 across the satellite link to the appropriate terminal 140. The terminal 140 then routes the traffic to the appropriate CPE 142.

According to at least one embodiment, the gateway 120 can include various components, implemented in hardware, software, or a combination thereof, to facilitate communication between the terminals 140 and external networks 150, 160 via the satellite 110. According to an embodiment, the gateway 120 can include a radio frequency transceiver (RFT) 122, a processing unit (or computer, CPU, etc.) 124, and a data storage unit (or storage unit) 126. While generically illustrated, the processing unit 124 can encompass various configurations including, without limitations, a personal computer, laptop, server, etc. As used herein, a transceiver corresponds to any type of antenna unit used to transmit and receive signals, a transmitter, a receiver, etc. The RFT 122 is usable to transmit and receive signals within a communication system such as the satellite communication system 100 illustrated in FIG. 1. The data storage unit 126 can be used, for example, to store and provide access to information pertaining to various operations in the satellite communication system 100. Depending on the specific implementation, the data storage unit 126 can be configured as a single drive, multiple drives, an array of drives configured to operate as a single drive, etc.

According to other embodiments, the gateway 120 can include multiple processing units 124 and multiple data storage units 126 in order to accommodate the needs of a particular system implementation. Although not illustrated in FIG. 1, the gateway 120 can also include one or more workstations 125 (e.g., computers, laptops, etc.) in place of, or in addition to, the one or more processing units 124. Various embodiments further provide for redundant paths for components of the gateway 120. The redundant paths can be associated with backup components capable of being seamlessly or quickly switched in the event of a failure or critical fault of the primary component.

According to the illustrated embodiment, the gateway 120 includes baseband components 128 which operate to process signals being transmitted to, and received from, the satellite 110. For example, the baseband components 128 can incorporate one or more modulator/demodulator units, system timing equipment, switching devices, etc. The modulator/demodulator units can be used to generate carriers that are transmitted into each spot beam and to process signals received from the terminals 140. The system timing equipment can be used to distribute timing information for synchronizing transmissions from the terminals 140.

According to an embodiment, a fault management unit 130 can be included in the gateway 120 to monitor activities and output one or more alerts in the event of a malfunction in any of the gateway components. The fault management unit 130 can include, for example, one or more sensors and interfaces that connect to different components of the gateway 120. The fault management unit 130 can also be configured to output alerts based on instructions received from a remotely located network management system (NMS) 170. The NMS 170 maintains, in part, information (e.g., configuration, processing, management, etc.) for the gateway 120, and all terminals 140 and beams supported by the gateway 120. The gateway 120 can further include a network interface 132, such as one or more edge routers, for establishing connections with a terrestrial connection point 134 from a service provider. Depending on the specific implementation, however, multiple terrestrial connection points 134 may be utilized.

Each terminal 140a-n can be configured for relaying traffic between its customer CPEs 140a-140n, a public network 150 such as the Internet, and/or its private network 160 across the satellite link and through gateway 120. The gateway 120 can be configured to route this traffic across the public network 150 and private network 160 as appropriate. The gateway 120 can be further configured to route traffic from the public 150 Internet and private network 160 across the satellite link to the appropriate terminal 140. The terminal 140 then routes the traffic to the appropriate CPE 140.

As illustrated in FIG. 1, the satellite communication system 100 facilitates communication between a satellite network, public networks 150, and private networks 160. Various embodiments, however, can also be configured for providing communication within only a terrestrial network (e.g., public communication networks 150 and private communication networks 160), or within only a satellite network. Thus, while FIG. 1 only illustrates components such as the terminals 130 and gateway 120, other network components such as, for example, a VPN router and a VPN gateway can be provided in place of, or in addition to, the illustrated terminal 130 and gateway 120. Furthermore, various embodiments can be incorporated within a router having QoS capabilities. Accordingly, the communication system 100 illustrated in FIG. 1 is only intended to be illustrative, and in no way restrictive.

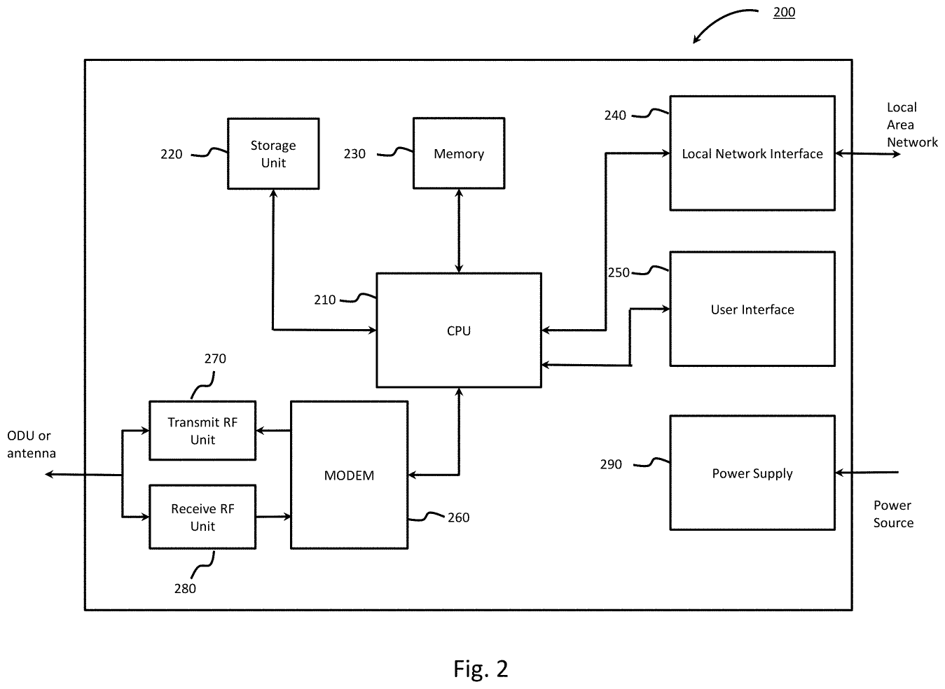

FIG. 2 is a diagram of an exemplary configuration for a terminal 200, such as used in the system of FIG. 1, according to one embodiment. Depending on the specific implementation, terminal 200 can be configured to operate as a stationary terminal 140 (e.g., VSAT), a mobile terminal 145, a transportable terminal, etc. The terminal 200 can include, for example, a CPU 210 coupled to a storage unit 220, a memory 230, a local network interface 240, a user interface 250, and a modem 260. Modem 260 is further coupled to a transmit radio frequency (RF) unit 270 and a receive RF unit 280. Although not explicitly shown, power supply 290 can be coupled to any of the blocks shown in terminal 200 that requires local electrical power. It should be noted that terminal 200 can include various additional components which perform conventional operations. Such components are well known to those skilled in the art and are omitted in order to provide better clarity and conciseness in describing the features of terminal 200.

CPU 210 can include one or more specifically built processing elements and/or general purpose processors configured or programmed to perform specific tasks associated with the operation, control, and management of activity in terminal 200. Storage unit 220 can be any one of several large and/or removable storage elements including, but not limited to, solid state disc, magnetic disc, and optical disc. Memory 230 can be any type of electronic circuit or small scale based storage elements including, but not limited to read-only memory (ROM), erasable electrically programmable ROM (EEPROM), random-access memory (RAM), non-volatile RAM (NVRAM), flash memory, or other similar memory technology. Storage unit 220 and/or memory 230 can be used to store instructions or software code used by CPU 210 and data associated with operations of terminal 200. Storage unit 220 can also be used for longer term storage of data and/or multimedia content transmitted and/or received through modem 260 or local network interface 240. Memory unit 230 can be used for shorter term or temporary storage of data and/or multimedia content needed for, or associated with, signal and data processing in terminal 200.

Local network interface 240 includes circuit elements configured for interfacing to one or more home networks and/or other similar local area networks (LANs). Local network interface 240 also includes interface components for connecting to the home networks and/or LANS either through a wired medium or wirelessly. Local network interface 240 receives data and/or multimedia content, along with processing instructions, from CPU 210 for delivery to devices such as CPEs 142 on the home and/or local area networks. For example, a home computer in a user's local home network employing Ethernet protocols can be interfaced to local network interface 240 through a registered jack (RJ) type 45 receptacle using category 5 (CAT 5) cable, CAT 6 cable, etc. Further, a user's cell phone can be connected wirelessly to local network interface 240 through an antenna (not shown) in order to utilize terminal 200 as part of a Wi-Fi signal router or hotspot.

User interface 250 can include a user input or entry mechanism, such as a set of buttons, a keyboard, or a microphone. User interface 250 can also include circuitry for converting user input signals into a data communication format to provide to processor 210. User interface 250 can further include some form of user notification mechanism to show device functionality or status, such as indicator lights, a speaker, or a display. User interface 250 can also include circuitry for converting data received from processor 210 to signals that can be used with the user notification mechanism.

Modem 260 performs all the functions necessary for modulating and demodulating a signal to/from transmit RF unit 270 and receive RF unit 280. These elements and/or functions can include, but are not limited to, digital signal conditioning, symbol mapping, demapping, data error correction encoding/decoding, and transport stream processing for interfacing data to and from the CPU 210. According to various embodiments, modem 260 can perform the modulating/demodulating functions independently or under control of the CPU 210. Transmit RF unit 270 processes the digital signal from modem 260 to form an analog signal for transmission through a satellite dish included as part of an outdoor unit (ODU) or an antenna (not shown). Receive RF unit 280 processes the analog signal received through the satellite dish or antenna to form a digital signal that is further processed in modem 260. The processing elements or functions in transmit RF unit 270 and receive RF unit 280 include, but are not limited to, signal amplification, filtering frequency up/downconversion, and analog to digital signal or digital to analog signal conversion.

According to an embodiment, the received satellite signal, operating in the Ka or Ku frequency bands is first block downconverted to the L band frequency range using very high frequency components in the ODU or antenna (not shown). The satellite signal can be transmitted in focused RF beams that carry data signals or streams on a plurality of modulated carriers. The focused beams can collectively cover a wider geographic region which defines the satellite network. The satellite signal can be encoded using one or more set of transmit parameters including, but not limited to, modulation symbol type (e.g., binary phase shift keying (BPSK), quadrature phase shift keying (QPSK)) and error correction coding rate (e.g., 1/2, 3/4, 1/5, 32/45). The transmit parameters can also include information associated with the arrangement of the data included in the signal, such as data framing, data slicing, or physical layer piping.

The downconverted received signal in the L band frequency range is provided to receive RF unit 280. Receive RF unit 280 processes the downconverted received signal to provide a digital signal representing the received signal to modem 260. Modem 260 processes the digital signal to produce a transport stream containing data that is associated with, or for delivery to, one or more user devices on a local area network (e.g., CPE 140). Modem 260 can also be configured to establish data synchronization based on the arrangement of the data. In some embodiments, modem 260 can include a circuit to detect and/or identify one or more types of data frames and demodulate and process the data content in a data frame based on the type of data frame that is detected. For example, the modem 260 can be configured to detect the presence of a VLSNR data frame in a manner that is separate from detection of the presence of another non-VLSNR data frame, such as a regular data frame. Modem 260 can demodulate and process each type of data frame based on detecting a first portion of the data frame or a second portion of the data frame. The data recovered from the received signal in modem 260 is processed in CPU 210 and provided to local network interface 240 for delivery as needed to the one or more user devices.

While FIG. 2 illustrates components such as modem 260, transmit RF unit 270, and receive RF unit 280, within terminal 200, it should be noted that various embodiments can allow for part, or all of, one or more of these components to be included in the ODU. Further, parts of one or more components can be combined or rearranged without altering the overall function and purpose of terminal 200. Thus, the specific arrangement shown in FIG. 2 should only be considered as illustrative and is in no way intended to be restrictive, as those skilled in the art would be able to implement such changes.

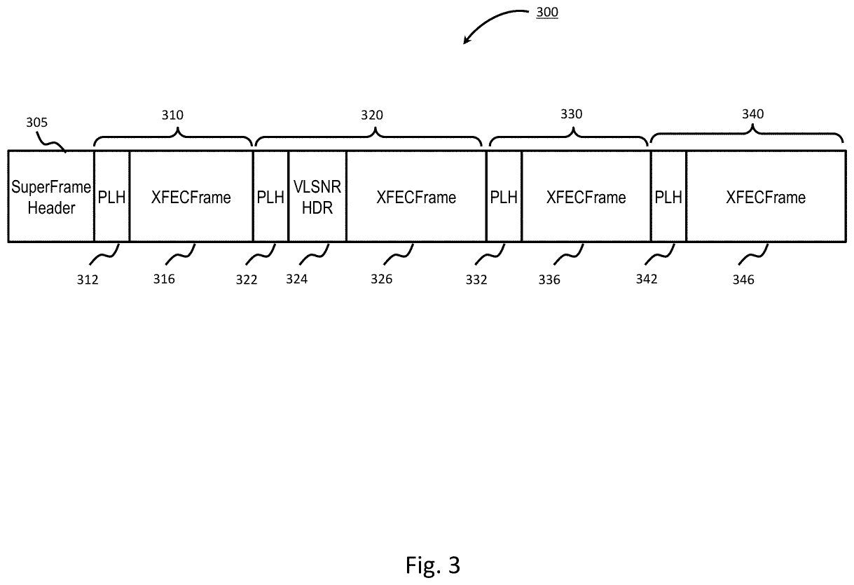

FIG. 3 is a diagram illustrating the format of an exemplary superframe 300 such as can be used in a communication system, such as satellite communication system 100 described in FIG. 1, and complying with the DVB-S2X standard. As shown in the illustration, the superframe 300 includes a superframe header 305 along with a series or sequence of data frames, e.g., frames 310, 320, 330, and 340. The superframe header 305 is followed by frame 310 that includes a first portion, referred to as Physical Layer Header (PLH) 312, followed by the body of the frame, referred to as a complex forward error correction (XFEC) frame 316. Frame 310 is followed by frame 320 which includes a PLH 322, similar to PLH 312. Frame 320 also includes a second portion, referred to as a VLSNR HDR 314, followed by the body, XFEC frame 326. Frame 320 is followed by two more frames 330 and 340, each including a PLH 332 and 342, followed by an XFEC frame 336 and 346 respectively. According to the illustrated embodiment, each frame 310, 320, 330, 340 is shown as having different sizes or lengths due to the presence of the VLSNR HDR and the varying lengths of XFEC frames. In some embodiments, more or fewer frames, as well as frames of equal sizes, can be present in a superframe similar to superframe 300.

The superframe header 305 can be, for example, 720 symbols in length and can include a superframe start or preamble indicator along with some indication of the format for the remainder of superframe 300. Several formats are possible which allow for flexibility to adjust the content of the superframe 300 depending on the operating requirements. Each PLH 312, 322, 332, and 342 can be 90 symbols in length and can include start of frame or preamble indicator with timing symbols. Each PLH 312, 322, 332, and 342 can also include information that indicates the signal modulation type, error correction rate, frame length, etc., for each of the respective frames 310, 320, 330, and 340. This information is commonly referred to as the physical layer signal (PLS) code. The modulation type and error correction rate are used by a demodulator, signal processing circuit, and/or FEC decoder to set up timing and data recovery for the frame. The length of frame information can be used to improve the ability of a demodulator or signal processing circuit (e.g., modem 260 in FIG. 2) to locate and recover the subsequent frame in embodiments that utilize variable frame lengths. In some embodiments, each PLH 312, 322, 332, and 342 can be extended to 180 symbols to include additional timing symbols and other information to assist in data recovery in more difficult signal reception environments. The VLSNR HDR 322 can be 900 symbols in length and primarily includes additional receiver synchronization symbol along with information, similar to the PLS code, used by the demodulator and/or signal processing circuit for receiving VLSNR signals that have an Es/No as low as −10 dB. Each of the XFEC frames 316, 316, 336, and 346 includes the data payload for the receiver that has been error correction encoded and modulated based on the PLS code that has been decoded from the respective PLHs 312, 322, 332, and 342.

As illustrated in FIG. 3 superframe 300 includes two different types of data frames, namely a VLSNR type data frame and a non-VLSNR (or regular) type of data frame. In some embodiments, other and/or additional types of data frames can be used. Further, different types of data frames can be used within the data stream of a received signal without incorporating those data frames into a superframe.

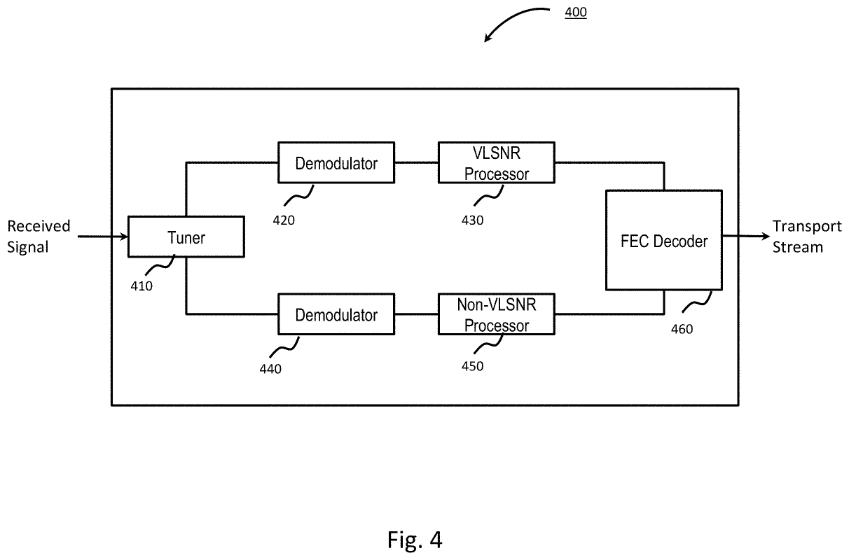

FIG. 4 illustrates a diagram of a decoding unit 400 capable of processing multiple types of frames in a data stream, in accordance with one or more embodiments. The decoding unit 400 can be incorporated as part of a signal receiving circuit, such as receive RF unit 280 and/or Modem 260, as described with respect to FIG. 2. The decoding unit 400 can be implemented in the form of Application Specific Integrated Circuit (ASIC), or other hardware, as described in greater detail below. For purposes of example, the decoding unit 400 will be described with respect to an arrangement of VLSNR and non-VLSNR frames similar to that described in FIG. 3.

According to the illustrated embodiment, a signal is received by the decoding unit 400 and provided to the tuner 410. The tuner 410 is coupled to both demodulator 420 and demodulator 440. Demodulator 420 is coupled to VLSNR processor 430. Demodulator 440 is coupled to non-VLSNR processor 450. Both VLSNR processor 430 and non-VLSNR processor 450 are coupled to forward error correction (FEC) decoder 460 which provides an output signal in the form of a data transport stream. As illustrated in FIG. 4, demodulator 420 along with VLSNR processor 430 form a VLSNR demodulator (or processing path, processing circuit, etc.) and demodulator 440 along with non-VLSNR processor 450 form a non-VLSNR demodulation path (or processing path, processing circuit, etc.). It should be noted that various other embodiments can support additional and/or different demodulation or processing circuits depending on the other specific types of data frames that must be processed.

Tuner 410 includes circuitry or functionality to filter and frequency convert the received signal, in either an analog or digital format. Tuner 410 provides a baseband, or near baseband, digital data stream signal in modulated symbol format to both demodulator 420 and demodulator 440. Each demodulator 420, 440 is configured to process digital data stream signals in a separate manner. More particularly, demodulator 420 is configured to demodulate only the VLSNR frames contained in the digital data stream signal. Demodulator 420 includes digital signal filtering, symbol timing and recovery, and equalization circuitry and/or functionality that are specifically configured to decode VLSNR frames. Demodulator 420 can be configured to detect and decode a superframe header (e.g., superframe header 305) information and timing, when present. The demodulator 420 can be further configured to continuously search the digital data stream in order to detect or identify a VLSNR frame header (e.g., VLSNR HDR 324) on 90 symbol boundaries. If the VLSNR frame header is detected, the remaining portion of the data frame (e.g., XFEC frame 326) is demodulated in demodulator 420 and provided to VLSNR processor 430. Demodulator 420 can provide symbol timing and synchronization, and symbol to bit demapping specific to a VLSNR frame. According to one or more embodiments, demodulator 420 can also be configured to detect or identify a physical layer header (e.g., PLH 312, PLH314). If a physical layer header is detected, it may be decoded to retrieve certain information, but the remaining portion of the data frame will not be demodulated unless a VLSNR frame header is also detected.

The VLSNR processor 430 further processes the demodulated data frame to capture any additional information associated with the digital data stream, such as timing information for a subsequent data frame. The VLSNR processor 430 also validates that the data frame has been properly demodulated as a VLSNR frame based on the modulation and coding information. The processed data frame is provided to FEC decoder 460 for decoding, based on the error correction coding, information associated with the data frame. Demodulator 420 initiates a new search for the next VLSNR header on the next 90 symbol interval after the end of the current data frame. Only VLSNR frames are demodulated as a result of detecting or identifying VLSNR headers. Other types of frames, such as non-VLSNR frames, are not detected due to absence of the VLSNR header.

Demodulator 440 is configured to demodulate only non-VLSNR frames contained in the digital data stream signal. Demodulator 440 can also be configured to detect and decode a superframe header information and timing, when present, in a manner similar to demodulator 420. Demodulator 440 can be further configured to continuously search the digital data stream signal provided by tuner 410 in order to detect or identify a physical layer header (e.g., PLH 312). Once the first physical layer header has been detected, it can be decoded to determine the characteristics associated with that data frame. The remaining portion of the data frame (e.g., XFEC frame 316) is demodulated based on the modulation and frame length information in the PLS code and other information from the decoded physical layer header, and provided to non-VLSNR processor 450. Demodulator 440 can provide symbol timing and synchronization, and symbol to bit demapping specific to a non-VLSNR frame.

According to at least one embodiment, even though every data frame includes a physical layer header as described, not every data frame is to be demodulated by demodulator 440. Information can be included in the physical layer header, for example, to indicate that the data frame is not a non-VLSNR frame (i.e., it is a VLSNR frame). According to an embodiment, a special indicator can be included as part of the coding information in the physical layer header for the data frame in order to identify the presence of a VLSNR frame. For example, an invalid error correction code rate, such as 129/132, can be included in the PLS code of the physical layer header associated with a VLSNR frame (e.g., PLH 322 in frame 320). If information in the physical layer header decoded by demodulator 440 indicates that the data frame is a VLSNR frame, demodulator 440 will not demodulate or process that data frame further. Only non-VLSNR frames are demodulated as a result of detecting or identifying non-VLSNR frames. Other types of frames, such as VLSNR frames described above, are not detected due to the fact that these other types of data frames include an indication that they are not non-VLSNR frames.

The non-VLSNR processor 450 further processes the demodulated non-VLSNR data frame in a manner similar to the processing of a VLSNR data frame performed by VLSNR processor 430. The processed data frame is provided to FEC decoder 460 for decoding based on the error correction coding information. Demodulator 440 initiates a new search for the next physical layer header. According to an embodiment, once a physical layer header (e.g., PLH 312) is decoded, the frame length information in the PLS code can be used to determine the approximate position or location of the physical layer header for the next data frame (e.g., frame 320). As a result, subsequent physical layer headers (e.g., PLH 322, 332, 342) can be more efficiently detected and decoded, and data frames demodulated and processed, if needed, by demodulator 440 and non-VLSNR processor 450 using the frame length information in each previous PLH.

The FEC decoder 460 receives a processed data frame from either VLSNR Processor 430 or non-VLSNR processor 450, and applies error correction decoding techniques based on code rate information provided from the PLS code. Examples of error correction decoding techniques include but are not limited to, Reed Solomon decoding, Bose-Chaudhuri-Hocquenghem (BLH) coding, turbo-coding, etc. The decoded data is formed into packets and included as part of a transport stream output.

According to the features of decoding unit 400, data from a single data stream is processed as two separate independent data streams containing a plurality of data frames. Thus, it becomes possible to simultaneously demodulate and process the incoming data frames as either VLSNR frames or non-VLSNR frames. The features of decoding unit 400 can minimize or mitigate any data loss due data timing synchronization issues associated with detecting and decoding different types of data frames in the same stream of data. In some embodiments, depending on the number of different frame types being processed, the symbol boundary relationship for detecting the headers or portions of the data frames can be adjusted to a value that differs from the 90 symbol boundary described here (e.g., a 180 symbol boundary), but can still be common for detecting the header or portion of the data frame that is different for each data frame type. Further, in some embodiments, data streams which utilize a non-superframe structure can use headers that are not aligned with a 90 symbol or 180 symbol boundary. The search and detection of VLSNR headers can be performed in demodulator 420 at every symbol time interval or correlated to a different factor which corresponds to a defined symbol boundary relationship.

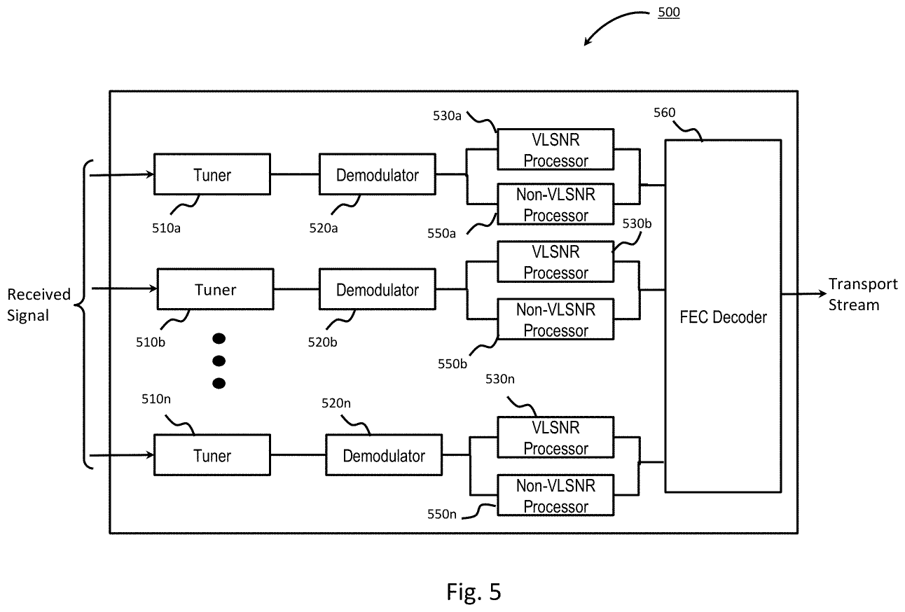

FIG. 5 illustrates a diagram of another exemplary decoding unit 500 capable of processing multiple types of frames in a data stream, in accordance with one or more embodiments. The decoding unit 500 can be incorporated as part of a signal receiving circuit, such as receive RF unit 280 and/or Modem 260 described in FIG. 2. The decoding unit 500 can be implemented in the form of Application Specific Integrated Circuit (ASIC), or other hardware, as described in greater detail below. For purposes of illustration, the decoding unit 500 will be described with respect to detection of VLSNR and non-VLSNR frames similar to that described in FIG. 3. It should be noted, however, that various embodiments can support different demodulation paths depending on the specific frames that must be detected.

A signal is received by the decoding unit 500 and provided to each of the tuners 510a-n. The signal can include one or more data streams containing data modulated as symbols onto one or more carriers in one or more beams from a satellite link. The data streams can all be different. Furthermore, one or more of the data streams can be the same but modulated differently and/or on differently. Each one of the tuners 510a-510n (collectively 510) is coupled to a corresponding one of the demodulators 520a-520n (collectively 520). Each one of the demodulators 520 is coupled to a corresponding one of the VLSNR processors 530a-530n (collectively 530) as well as a corresponding one of the non-VLSNR processors 550a-550n (collectively 550). The VLSNR processors 530, as well as the Non-VLSNR processors 550, are coupled to FEC decoder 560 which provides an output signal in the form of a data transport stream. Except as described below, the operation of tuners 510, demodulators 520, VLSNR processors 530, non-VLSNR processors 550, and FEC decoder 560 are similar to that described for tuner 410, demodulators 420 and 440, VLSNR processor 430, non-VLSNR processor 450, and FEC decoder 460. Accordingly, such functionality will not be described again in detail here.

As illustrated, decoding unit 500 includes n parallel received signal processing paths. Each parallel received signal processing path includes a tuner 510a-n and a demodulator 520a-n, as well as a VLSNR processor 530a-n and a non-VLSNR processor 550a-n. Each demodulator 520a-n is configured to detect both the physical layer headers, (e.g., PLH 312 in FIG. 3, etc.) in the some or all data frames (e.g., data frame 310, etc.) as well as the VLSNR headers (e.g., VLSNR HDR 324) when present in the VLSNR frames (e.g., data frame 320). Each demodulator 520a-n outputs a demodulated data stream to one of the VLSNR processors 530a-n as well as one of the non-VLSNR processors 550a-n. The VLSNR processors 530a-n process the demodulated data stream to recover the body of the VLSNR data frame (e.g., XFEC frame 316) if it is determined by the demodulator 520 (or the VLSNR processor) that the data frame is a VLSNR frame. The body of the VLSNR data frame is subsequently supplied to FEC decoder 560.

The decode unit 500 is capable of tuning, demodulating, and decoding more than one carrier or transponder from the satellite simultaneously. This can provide additional capabilities for high data rate applications, mobile applications, as well as situations with marginal signal conditions. According to one embodiment, data content, such as a high data rate media stream that cannot be contained on a signal carrier, can be separated and included on different carriers or transponders as part of uplink transmission to the satellite. The decoding unit 500 can tune the different carriers in the received signal using different tuners 410a-n and process the plurality of data streams (e.g., as data frames) from each of the carriers to provide the data as a transport stream.

According to another embodiment, two different carriers containing the same or similar data streams can be received by two of the tuners 410a-n simultaneously as part of a handover procedure. Handovers are often needed to facilitate uninterrupted service to deliver the data stream when a mobile terminal is moved out of beam carrying a first carrier from the satellite to a new beam carrying a second carrier which overlays the mobile terminal's current location. A make-before-break handover can be employed, where the terminal can use the second carrier to establish a connection to the gateway before the connection to the first carrier is broken. Accordingly, an ongoing session that is providing the data stream can be transferred from one carrier to another without disruption.

As described above, as part of detecting physical layer headers, the information that is decoded can include timing information for the next data frame, such as the length of the current data frame. However, the inclusion of VLSNR headers can create uncertainty of proper timing for the subsequent physical layer header. Additionally, in situations where the received signal is operating at a lower Es/No, such as at a level below 0 dB, proper detection and decoding of physical layer headers (e.g., PLH 312) may not be reliable or even possible, while proper detection and decoding of VLSNR headers (e.g., VLSNR HDR 324) can continue reliably. As a result, VLSNR header detection has a higher level of trust than the PLH detection. In order to address reliability issues associated with reliable data recovery from the received signal, one or more handshaking techniques can be implemented to share information between a VLSNR processor 530 and its corresponding non-VLSNR processor 550. For example, at every opportunity where a VLSNR header is detected and decoded for a data frame, information such as the PLS code or previously decoded PLH is examined. If the information (e.g., PLS code) for the corresponding or previously decoded PLH does not agree with the information decoded from the VLSNR header, then the VLSNR detection by the VLSNR processor is given a higher level of trust than the detection by the non-VLSNR processor. Further demodulation and processing in the non-VLSNR processor can be stopped while information, such as the frame length, can be communicated from the VLSNR processor to assist in getting the non-VLSNR processor resynchronized. As a result, information for the VLSNR processor is communicated as a handshake mechanism to the non-VLSNR processor for detecting the start of the next data frame. Further details regarding handshaking techniques will be described below.

According to various embodiments, the VLSNR processors 530a-n and non-VLSNR processors 550a-n are the same as the VLSNR processor 430 and non-VSLNR processor 450 described in FIG. 4. However, the operations performed within VLSNR processors 530a-n and non-VLSNR processors 550a-n can be adjusted based on operational efficiency or other needs. For example, the VLSNR processors 530a-n and non-VLSNR processors 550a-n can include additional functionality, such as PLH and VLSNT HDR decoding, that is typically included in a demodulator (e.g., demodulator 420 and demodulator 440). As a result, in some embodiments, each one of the demodulators 520a-n along with the corresponding one of the VLSNR processors 530a-n and the corresponding one of the non-VLSNR processors 550a-n can be collectively referred to as a demodulator, a data frame type specific demodulator, or a data frame type specific processor.

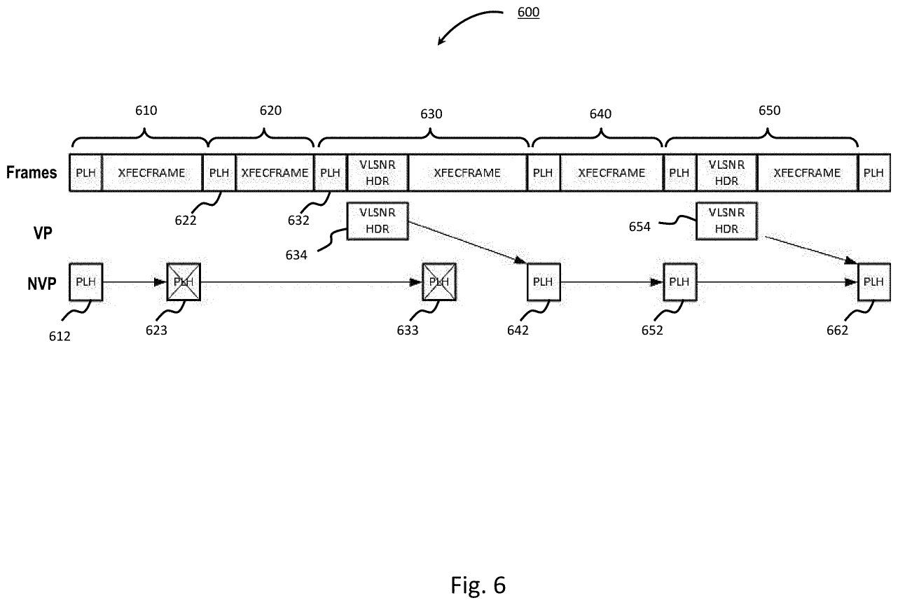

FIG. 6 is a diagram for illustrating a handshaking mechanism 600 between the VLSNR and non-VLSNR processors in a decoding unit, according to an embodiment. The handshaking mechanism 600 can be used between the VLSNR processors and non-VLSNR processors described in decoding unit 500 (see FIG. 5) in order to better manage issues that arise from using only a single demodulator for each carrier in the received signal or from data frames multiple carriers as part of reception of a data stream. The handshake mechanism 600 can also be used between the VLSNR processors and non-VLSNR processors described in decoding unit 500 in order to improve performance of the demodulator used for non-VLSNR data frames

As previously discussed, VLSNR detection and processing proceeds in the VLSNR processor (e.g., VLSNR processors 530a-n) independently of any input from PLH detection and processing that is done in the non-VLSNR processor (e.g., non-VLSNR processors 550a-n). This is also done whenever a VLSNR frame is not currently being decoded and processed by the non-VLSNR processor. Handshake mechanism 600 includes three rows labeled “Frames”, “VP” (VLSNR Processor), and “NVP” (Non-VLSNR Processor), respectively. The first row illustrates a series of data frames 610, 620, 630, 640, and 650. According to the illustrated embodiment, data frames 630 and 650 are VLSNR data frames, while the remaining frames are non-VLSNR frames. The second row illustrates detection and decoding of VLSNR headers for data frames 630 and 650 by a VLSNR processor. The third row illustrates detection and decoding of PLHs for all of the data frames by a non-VLSNR processor.

As illustrated in FIG. 6, PLH 612 for data frame 610 is initially detected by the NVP and decoded to determine, in part, the frame length. An error occurs during detection and decoding, thereby resulting in an incorrect determination of frame length, included as part of the PLS code. The error can be due to a number of issues, including the received signal having too low of a SNR for proper decoding or the data frame utilizing a modulation and/or coding rate that requires a higher SNR than the SNR of the received signal. The incorrect PLS code from PLH 312, including the incorrect frame length for data frame 310, is communicated to the VP. The incorrect frame length for data frame 610 leads the NVP to attempt detection of the next PLH at the location of PLH 623 rather than the correct location of PLH 622 for data frame 620. Further, the NVP incorrectly decodes the data present at the location of PLH 623, thereby creating another incorrect determination of frame length as part of an incorrect PLS code for data frame 620. The incorrect PLS code from PLH 622 is again communicated to the VP. The incorrect frame length for data frame 620 leads the NVP to attempt detection of the next PLH at the location of PLH 633 rather than the proper location of PLH 632 for data frame 630.

VLSNR HDR 634 is detected by the VP and decoded to determine, among other things, the frame length for data frame 630. The VP invalidates the frame length for data frame 620 provided by the NVP since the location of the VLSNR HDR 634, which is preceded by the correct PLH 632, is before the location of the incorrect PLH 633 for data frame 630. The frame length for data frame 630, determined by the VP from VLSNR HDR 634, is communicated to the NVP. The NVP uses the newly received frame length for data frame 330 to re-establish timing for detecting PLH 642 for data frame 640. PLH 642 is correctly decoded and identifies the correct frame length for data frame 640 to lead the NVP to correctly detect and decode the PLH 652 for data frame 650. The correct PLS code for data frame 640 is subsequently communicated to the VP.

As previously discussed, physical layer headers for VLSNR data frames can include a special indicator, such as an invalid code rate, to allow the NVP to limit or prevent further processing of these data frames. According to one or more embodiments, physical layer headers for non-VLSNR data frames can include information for the frame length in order to assist the NVP in detecting the PLH for the next data frame. In such embodiments, while the special indicator on PLH 652 identifies the data frames and VLSNR data frame, the correctly decoded PLH 652 identifies the correct frame length for the NVP to correctly detect and decode the PLH 662 for the next data frame (not shown). The correct PLS code for data frame 650 is communicated to the VP. Further, the VLSNR HDR 654 is detected by the VP and decoded to determine, among other things, the frame length for data frame 650. The frame length for data frame 650, determined by the VP from VLSNR HDR 654, is also communicated to the NVP.

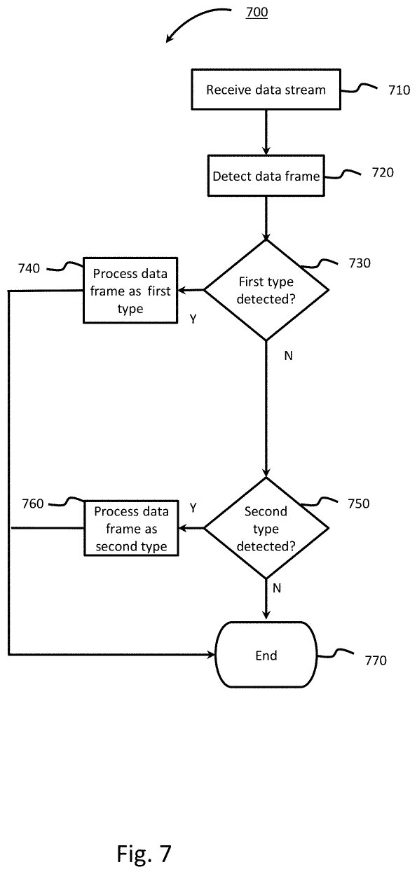

FIG. 7 is a flowchart of an exemplary process 700 for decoding different types of data frames, according to one embodiment. Process 700 can be implemented as part of the operation of a decoding unit, such as decoding unit 500. Process 700 can equally be implemented as part of the operation of decoding unit 400. Process 700 can further be incorporated into a terminal, such as terminal 200, in the form of hardware, software, or a combination thereof.

At step 710, a signal in the form of a data stream is received at a terminal. According to an embodiment, the data stream can be modulated and encoded in accordance with predetermined transmit parameters, and transmitted from the gateway to the terminal. More particularly, the gateway transmits the signal on an outroute path to different terminals along a bent pipe path facilitated by the satellite. The data stream is provided to one or more of the tuners 510 in the form of a plurality of data frames arranged in sequence. Each of the data frames can be one of several types of data frames. The types of data frames can include, but are not limited to, VLSNR data frames, non-VLSNR data frames, etc.

At step 720, the data stream is detected for a particular data frame in the series or sequence of data frames. According to an embodiment, step 720 can be carried out in one of the demodulators 520. Step 720 can include, for example, detecting a first portion of the data frame and detecting a second portion of the data frame. The first portion can be a first header and the second portion can be a second header that is different from the first header. As an example, the first header can contain a short preamble used for synchronization along with information associated with the data frame. The second header can contain a longer preamble also used for synchronization. Further, the first header can be present in each data frame regardless of data frame type, while the second header can be present only for one specific data frame type. If either or both the first portion of the data frame and the second portion of the data frame is detected, it is decoded in a demodulator (e.g., demodulators 520). Alternatively, or additionally, or one or more of data frame type specific processors (e.g., VLSNR processors 430 or non-VLSNR processors 550) can be used to process and capture additional information about the data frame.

At step 730, a determination is made as to whether the detected data frame is of a first type. According to an embodiment, the first type of data frame can be a non-VLSNR data frame. The determination, at step 730, can further include detecting the presence of the first portion of the data frame being a first header. The determination, at step 730, can also include decoding the information in the first header to determine if the first header includes an indicator that the data frame is a different type of frame, such as a VLSNR frame. In some embodiments, the indicator can be an invalid error correction code as described above.

If the data frame is detected to be the first type, then, at step 740, the remainder of the data frame is demodulated and processed as a first type of data frame. The demodulation and processing, at step 740, can be performed in a processing circuit that is specific to demodulating and/or processing the data frame as a first type of data frame, such as one or more of the non-VLSNR processing circuits 550. The process 700 would subsequently end at step 770. According to some embodiments, the processing circuit can also include a demodulator specific to demodulating the first type of data frame, such as demodulator 440.

If the data frame is not detected to be the first type, then, at step 750, a determination is made as to whether a second type of data frame is detected. For example, the second type of data frame can be a VLSNR data frame. The determination, at step 750, can include detecting the second portion of the data frame being a VLSNR HDR. If the data frame is detected as the second type, then the remainder of the data frame is processed as a second type of data frame, at step 760. According to an embodiment, step 760, can include demodulation and processing performed in a processing circuit that is specific to demodulating and/or processing a second type of data frame, such as one or more of the VLSNR processing circuits 530. The process 700 would subsequently end. Furthermore, if the data frame is not detected as a second type, then process 700 ends.

Depending on specific operating conditions and/or atmospheric conditions, it is possible that the data frame is not detected as either a first type (e.g., non-VLSNR) or a second type (e.g., VLSNR). For example, the data frame may not be recognized because of errors introduced into the data stream during transmission that affect the first and/or second portions of the data frame due to, for instance, low Es/No for the received signal (e.g., less than −10 db). According to an embodiment, an indication can be provided to the processor in the terminal (e.g., terminal 200), that the data frame is invalid.

As can be appreciated, the data stream can be received over an extended period of time and include numerous individual data frames. Accordingly, some or all the steps of process 700 can be repeated on a periodic or data frame by data frame basis. Further, additional steps can be added to process 700 for detecting and determining additional data frame types. In particular, steps 750 and 760 can be repeated again for a third or further data frame type based on the number of data frame types in the set of data frame types. The detecting, at step 720, can also be expanded to include detecting additional portions of the data frame and/or detecting specific combinations of portions of the data frame.

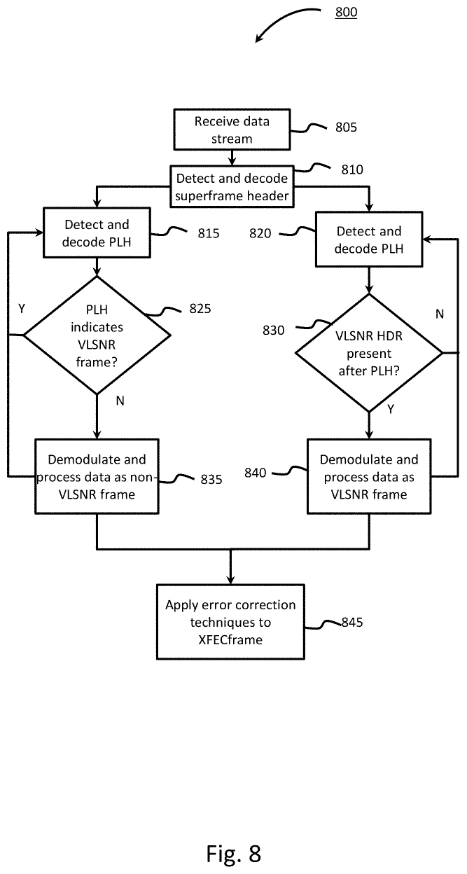

FIG. 8 is a flowchart of a process 800 for decoding different types of data frames, according to various embodiments. Process 800 can be implemented as part of the operation of a decoding unit, such as decoding unit 400. Process 800 can equally be implemented as part of the operation of decoding unit 500. Process 800 can further be incorporated into a terminal, such as terminal 200, in the form of hardware, software, or a combination thereof. Further, process 800 is implemented utilizing a data stream having a superframe structure, such as superframe 300. Process 800 can equally be implemented utilizing other data frame structures, such as described with respect to FIG. 7.

At step 805, a data stream is received at a terminal. The data stream is provided to tuner 410 in the form of a plurality of superframes (e.g., superframes 300) arranged in sequence. At step 810, a superframe header is detected. This can be done, for example, in demodulator 420 and/or demodulator 440. As part of the detection, at step 810, the superframe header is decoded to recover information associated with one or more of the data frames included therein.

At step 815, the presence of the PLH for a data frame is detected using, for example, demodulator 440. The PLH is further decoded to retrieve information associated with the data frame. According to an embodiment, the information includes the PLS code containing the data frame length. At step 825, a determination is made as to whether the information decoded from the PLH is indicative of the data frame being a VLSNR data frame. According to an embodiment, an invalid error correction rate in the PLS code can indicate a VLSNR data frame.

If, at step 825, the determination is made that the PLH does not indicate a VLSNR data frame, then, at step 835, the XFEC frame would continue to be demodulated and processed based on the information decoded from the PLH. This can be done, for example, using demodulator 440 and non-VLSNR processor 450. At step 845, one or more error correction techniques are applied to the demodulated and processed XFEC frame based on information, such as code rate, from the PLH. The one or more error correction techniques are applied by an appropriate decoder such as, for example, FEC decoder 460. Further, at step 835, process 800 subsequently returns to step 815 to detect and decode the next data frame in the superframe.

If, at step 825, the determination is made that the PLH indicates a VLSNR data frame, then demodulator 440 and non-VLSNR processor 450 do not process the XFEC frame. Control of process 800 subsequently returns to step 815. At step 820, the PLH is also detected using, for example, demodulator 420. The PLH is further decoded to retrieve information associated with the data frame including the PLS code containing the data frame length. As described with respect to step 825, in some cases, such as when the data frame is not a VLSNR frame, demodulator 420 may be unable to detect and/or decode the PLH. In these cases, the information included in the PLH may not be decoded. At step 820, the presence of a VLSNR HDR in the data frame after the PLH is also detected by demodulator 420.

At step 830, a determination is made as to whether a VLSNR HDR for the data frame is present or has been detected by demodulator 420. Step 830 can further include decoding the VLSNR HDR to retrieve information associated with VLSNR decoding for the particular data frame 310. According to an embodiment, the information in the VLSNR HDR can include information similar to the information in the PLH, such as the PLS code. If, at step 830, the determination is made that a VLSNR HDR is not present or has not been detected, then process 800 returns to detecting the next data frame, at step 820, without further processing of data frame. If, at step 830, the determination is made that a VLSNR HDR has been detected and decoded, then the XFEC frame continues to be demodulated and processed based on the information decoded from the VLSNR HDR. At step 845, one or more error correction techniques are applied to the demodulated and processed XFEC frame, based on information, such as code rate, from the PLH. According to an embodiment, the one or more error correction techniques can be applied by FEC decoder 460. Further, at step 840, process 800 subsequently returns to step 820 to detect and decode the next data frame in the superframe.

As described with respect to superframe 300, data frame 310 is processed as a non-VLSNR frame based on the determination at step 825 as well as the determination at step 830. Accordingly, data frame 320 will be processed as a VLSNR frame. Data frames 330 and 340 will be processed as non-VLSNR frames. Process 800 illustrates steps 815, 825, 835, and 845 in a first path parallel with steps 820, 830, 840, and 850 and the steps in each of the paths are described as being performed on the same data frame in different elements in a decoder, such as decoding unit 400. Accordingly, the steps in each of those paths can be performed in the same or similar timeframe. According to some embodiments, additional steps can be added to process 800 for detecting and determining additional data frame types. In particular, steps 820, 830, and 840 can be repeated again for a third or further data frame type as separate parallel processing paths based on the number of data frame types in the set of data frame types. The detecting, at steps 815 and 820, can also be expanded to include detection of additional portions of the data frame and/or detection of specific combinations of portions of the data frame.

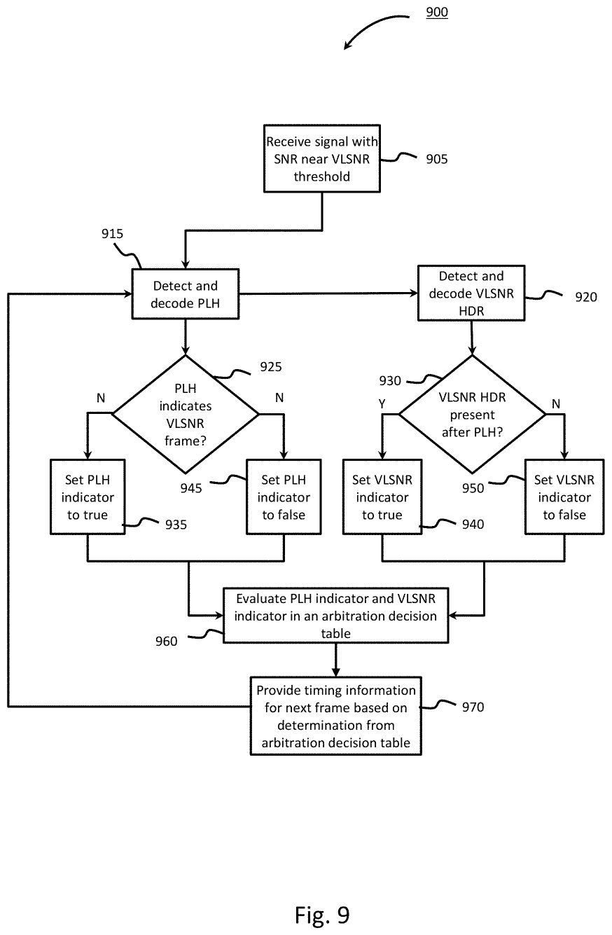

FIG. 9 is a flowchart of a process 900 for decoding different types of data frames, according to one or more embodiments. Process 900 can be implemented as part of the operation of a decoding unit, such as decoding unit 500. Process 800 can equally be implemented as part of the operation of decoding unit 400. Process 900 can further be incorporated into a terminal, such as terminal 200, in the form of hardware, software, or a combination thereof. Further, process 900 can be applied to a data stream having a superframe structure, such as described with respect to FIG. 3. Process 900 can equally be implemented utilizing other data frame structures.

Process 900 describes a process that includes a handshaking mechanism that utilizes information decoded from a data frame that is a first type of data frame to assist in detecting another subsequent data frame that is a second type of data frame. The handshaking mechanism provides the data stream to one demodulator that can process both the PLH and, if present, the VLSNR HDR for the same data frame. According to the illustrated embodiment, the handshaking mechanism includes a determination of one or more characteristics associated with information from the PLH and/or VLSNR HDR in a data frame that is detected and decoded as both a VLSNR frame and non-VLSNR frame in one of the demodulators 500. According to an embodiment, results from the determination can be evaluated using an arbitration decision table. The decision identified from the arbitration decision table is used to determine whether the information from the PLH or from the VLSNR HDR should be used for detecting and decoding the next data frame.

At step 905, a signal is received at one of the tuners 510 from a network, such as a satellite network. The signal includes one or more data streams with each data stream having a plurality of data frames. The SNR of the signal is near the threshold for receiving and decoding VLSNR frames. According to an embodiment the SNR of the signal is between −2.5 dB and +5 dB.

At step 915 the presence of the PLH for a data frame in one of the data streams is detected in one of the demodulators 520 in a manner similar to that discussed previously. The PLH is further decoded to retrieve information associated with the data frame including the PLS code containing the data frame length. According to some embodiments, the PLH can be decoded and processed in the same demodulator 520. According to some embodiments, the PLH can be decoded and processed in one of or both the corresponding non-VLSNR processor 550 and the corresponding VLSNR processor 530. According to an embodiment, the PLH is decoded and processed in the non-VLSNR processor 550 to recover the PLS code for the data frame.

At step 925, a determination is made as to whether the PLS code in the PLH includes an indication (e.g., a code rate of 129/132) that the data frame is a VLSNR data frame. If the determination is made that the PLS code does not include the indication that the data frame is a VLSNR data frame (i.e., is not a VLSNR data frame), then a PLH indicator for the data frame is set to true, at step 935. If the PLS code includes information indicative of a VLSNR data frame, then the PLH indicator is set to false, at step 945. At step 920, presence of a VLSNR HDR for the same data frame is detected using the same demodulator used to detect the presence of the PLH at step 915. When the VLSNR HDR is detected, it is decoded to retrieve information associated with the VLSNR frame including the data frame length. According to an embodiment, the VLSNR frame is decoded in the corresponding VLSNR processor 530. At step 930, a determination is made as to whether the VLSNR HDR for the data frames present in the data frame. If the VLSNR HDR is determined to be present, then a VLSNR indicator for the data frame is set to true, at step 940. If the determination is made that a VLSNR HDR is not present, then the VLSNR indicator is set to false, at step 950.

At step 960, the PLH indicator and the VLSNR indicator are evaluated. According to some embodiments, the evaluation can be performed in either the non-VLSNR processor or the VLSNR processor. According to other embodiments, the evaluation can be performed in a main processing unit of the terminal, such as CPU 210 in FIG. 2. According to the illustrated embodiment, the evaluation can be performed using an arbitration decision table. The arbitration decision table can identify the most trusted or reliable source of information based on decoding the PLH and/or the VLSNR HDR for the data frame. Table 1 illustrates an exemplary arbitration decision table. Table 1 includes four decision outputs based on the possible combinations of the values for the PLH indicator and the VLSNR indicator as described previously.

TABLE 1

| PLH | VLSNR | |
|---|---|---|
| Indicator | Indicator | Decision |
| True | True | Trust decoded PLS code |
| False | True | Trust VLSNR HDR information |
| True | False | PLS code not reliable, frame synchronization |
| | | lost, resynchronize |
| False | False | Trust decoded PLS code |

At step 970, information from either the PLH or the VLSNR HDR is provided to the demodulator 520 for detecting the PLH for the next data frame, at step 915. According to one embodiment, the information includes at least the frame length for the current data frame. The frame length can be used by the demodulator 520 to determine an estimated time for the beginning of the next data frame.

According to some embodiments, an arbitration decision table can be used to make the determination of whether information from the PLH or information from the VLSNR HDR is provided. According to the illustrated embodiment using table 1, when the PLH indicator and the VLSNR indicator are either both true or both false, the PLS code is the most trusted. Accordingly, the information from the PLH is provided. When the PLH indicator is false and the VLSNR indicator is true, the VLSNR HDR is the most trusted. Accordingly, the information from the VLSNR HDR is provided. When the PLH indicator is true and the VLSNR indicator is false, neither the PLH nor the VLSNR HDR can be trusted. Accordingly, no timing information is provided. The demodulator 520 detects the next data frame, without any previous synchronization, in a manner similar to detecting an initial data frame. According to some embodiments, the decision arbitration table can include decisions that indicate the VLSNR HDR is always more reliable and trusted when the VLSNR indicator is true regardless of the value for the PLH. According to such embodiments, the information from the VLSNR HDR would be provided.

According to some embodiments, additional steps can be added to process 900 for detecting and determining additional data frame types as discussed previously. The detecting step for the additional data frame types can also be expanded to include detecting additional portions of the data frame and/or detecting specific combinations of portions of the data frame. The arbitration decision table can also be expanded to include additional indicators. Further, one or more steps in process 900 can be included in either process 700 or process 800.

Various features described herein can be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Furthermore, various features can be implemented using algorithms illustrated in the form of flowcharts and accompanying descriptions. Some or all steps associated with such flowcharts can be performed in a sequence independent manner, unless otherwise indicated. Those skilled in the art will also understand that features described in connection with one Figure can be combined with features described in connection with another Figure. Such descriptions are only omitted for purposes of avoiding repetitive description of every possible combination of features that can result from the disclosure.

The terms software, computer software, computer program, program code, and application program can be used interchangeably and are generally intended to include any sequence of machine or human recognizable instructions intended to program/configure a computer, processor, server, etc. to perform one or more functions. Such software can be rendered in any appropriate programming language or environment including, without limitation: C, C++, C#, Python, R, Fortran, COBOL, assembly language, markup languages (e.g., HTML, SGML, XML, VoXML), Java, JavaScript, etc. As used herein, the terms processor, microprocessor, digital processor, and CPU are meant generally to include all types of processing devices including, without limitation, single/multi-core microprocessors, digital signal processors (DSPs), reduced instruction set computers (RISC), general-purpose (CISC) processors, gate arrays (e.g., FPGAs), PLDs, reconfigurable compute fabrics (RCFs), array processors, secure microprocessors, and application-specific integrated circuits (ASICs). Such digital processors can be contained on a single unitary IC die, or distributed across multiple components. Such exemplary hardware for implementing the described features is detailed below.

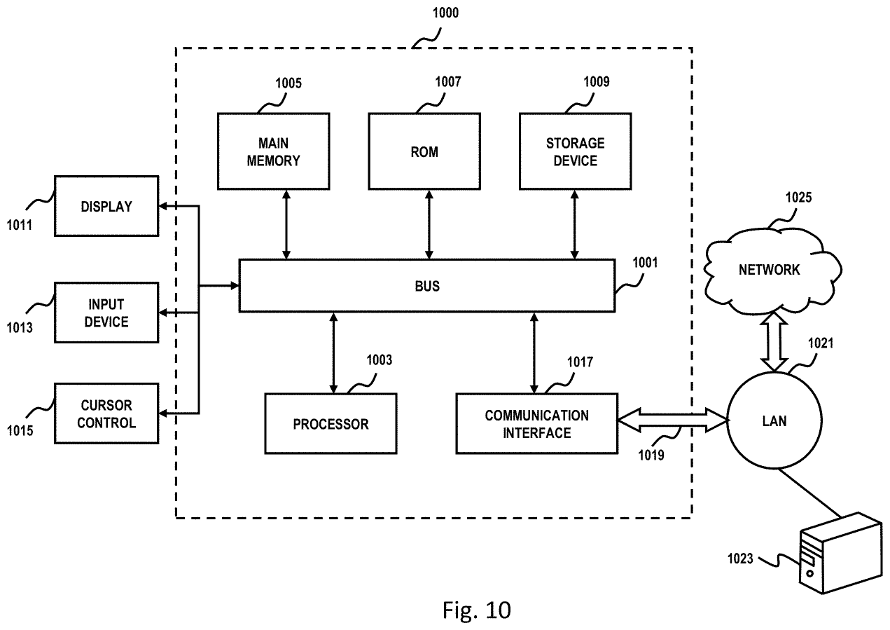

FIG. 10 is a diagram of a computer system that can be used to implement features of various embodiments. The computer system 1000 includes a bus 1001 or other communication mechanism for communicating information and a processor 1003 coupled to the bus 1001 for processing information. The computer system 1000 also includes main memory 1005, such as a random access memory (RAM), dynamic random access memory (DRAM), synchronous dynamic random access memory (SDRAM), double data rate synchronous dynamic random-access memory (DDR SDRAM), DDR2 SDRAM, DDR3 SDRAM, DDR4 SDRAM, etc., or other dynamic storage device (e.g., flash RAM), coupled to the bus 1001 for storing information and instructions to be executed by the processor 1003. Main memory 1005 can also be used for storing temporary variables or other intermediate information during execution of instructions by the processor 1003. The computer system 1000 can further include a read only memory (ROM) 1007 or other static storage device coupled to the bus 1001 for storing static information and instructions for the processor 1003. A storage device 1009, such as a magnetic disk or optical disk, is coupled to the bus 1001 for persistently storing information and instructions.

The computer system 1000 can be coupled via the bus 1001 to a display 1011, such as a light emitting diode (LED) or other flat panel displays, for displaying information to a computer user. An input device 1013, such as a keyboard including alphanumeric and other keys, is coupled to the bus 1001 for communicating information and command selections to the processor 1003. Another type of user input device is a cursor control 1015, such as a mouse, a trackball, or cursor direction keys, for communicating direction information and command selections to the processor 1003 and for controlling cursor movement on the display 1011. Additionally, the display 1011 can be touch enabled (i.e., capacitive or resistive) in order to facilitate user input via touch or gestures.

According to an exemplary embodiment, the processes described herein are performed by the computer system 1000, in response to the processor 1003 executing an arrangement of instructions contained in main memory 1005. Such instructions can be read into main memory 1405 from another computer-readable medium, such as the storage device 1009. Execution of the arrangement of instructions contained in main memory 1005 causes the processor 1403 to perform the process steps described herein. One or more processors in a multi-processing arrangement can also be employed to execute the instructions contained in main memory 1005. In alternative embodiments, hard-wired circuitry can be used in place of or in combination with software instructions to implement exemplary embodiments. Thus, exemplary embodiments are not limited to any specific combination of hardware circuitry and software.

The computer system 1000 also includes a communication interface 1017 coupled to bus 1401. The communication interface 1017 provides a two-way data communication coupling to a network link 1019 connected to a local network 1021. For example, the communication interface 1017 can be a digital subscriber line (DSL) card or modem, an integrated services digital network (ISDN) card, a cable modem, fiber optic service (FiOS) line, or any other communication interface to provide a data communication connection to a corresponding type of communication line. As another example, communication interface 1017 can be a local area network (LAN) card (e.g., for Ethernet™ or an Asynchronous Transfer Mode (ATM) network) to provide a data communication connection to a compatible LAN. Wireless links can also be implemented. In any such implementation, communication interface 1017 sends and receives electrical, electromagnetic, or optical signals that carry digital data streams representing various types of information. Further, the communication interface 1017 can include peripheral interface devices, such as a Universal Serial Bus (USB) interface, a High Definition Multimedia Interface (HDMI), etc. Although a single communication interface 1017 is depicted in FIG. 10, multiple communication interfaces can also be employed.

The network link 1019 typically provides data communication through one or more networks to other data devices. For example, the network link 1019 can provide a connection through local network 1021 to a host computer 1023, which has connectivity to a network 1025 such as a wide area network (WAN) or the Internet. The local network 1021 and the network 1025 both use electrical, electromagnetic, or optical signals to convey information and instructions. The signals through the various networks and the signals on the network link 1019 and through the communication interface 1017, which communicate digital data with the computer system 1000, are exemplary forms of carrier waves bearing the information and instructions.

The computer system 1000 can send messages and receive data, including program code, through the network(s), the network link 1019, and the communication interface 1017. In the Internet example, a server (not shown) might transmit requested code belonging to an application program for implementing an exemplary embodiment through the network 1025, the local network 1021 and the communication interface 1017. The processor 1003 can execute the transmitted code while being received and/or store the code in the storage device 1009, or other non-volatile storage for later execution. In this manner, the computer system 1000 can obtain application code in the form of a carrier wave.

The term “computer-readable medium” as used herein refers to any medium that participates in providing instructions to the processor 1003 for execution. Such a medium can take many forms, including but not limited to non-volatile media, volatile media, and transmission media. Non-volatile media include, for example, optical or magnetic disks, such as the storage device 1009. Non-volatile media can further include flash drives, USB drives, microSD cards, etc. Volatile media include dynamic memory, such as main memory 1005. Transmission media include coaxial cables, copper wire and fiber optics, including the wires that comprise the bus 1001. Transmission media can also take the form of acoustic, optical, or electromagnetic waves, such as those generated during radio frequency (RF) and infrared (IR) data communications. Common forms of computer-readable media include, for example, a USB drive, microSD card, hard disk drive, solid state drive, optical disk (e.g., DVD, DVD RW, Blu-ray), or any other medium from which a computer can read.

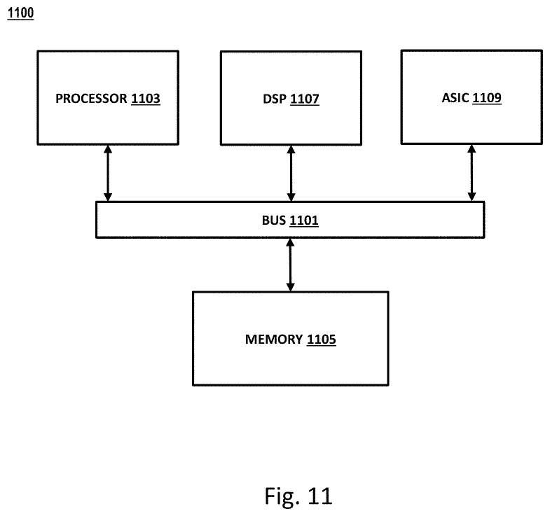

FIG. 11 illustrates a chip set 1100 upon which features of various embodiments can be implemented. Chip set 1100 is programmed to implement various features as described herein and includes, for instance, the processor and memory components described with respect to FIG. 15 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1100, or a portion thereof, constitutes a means for performing one or more steps of the figures.

In one embodiment, the chip set 1100 includes a communication mechanism such as a bus 1101 for passing information among the components of the chip set 1100. A processor 1103 has connectivity to the bus 1101 to execute instructions and process information stored in, for example, a memory 1105. The processor 1103 can include one or more processing cores with each core configured to perform independently. A multi-core processor enables multiprocessing within a single physical package. Examples of a multi-core processor include two, four, eight, or greater numbers of processing cores. Alternatively, or in addition, the processor 1103 can include one or more microprocessors configured in tandem via the bus 1101 to enable independent execution of instructions, pipelining, and multithreading. The processor 1103 can also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to perform specialized functions not easily performed by a general purpose processor. Other specialized components to aid in performing the inventive functions described herein include one or more field programmable gate arrays (FPGA) (not shown), one or more controllers (not shown), or one or more other special-purpose computer chips.

The processor 1103 and accompanying components have connectivity to the memory 1105 via the bus 1101. The memory 1105 includes both dynamic memory (e.g., RAM, magnetic disk, rewritable optical disk, etc.) and static memory (e.g., ROM, CD-ROM, DVD, BLU-RAY disk, etc.) for storing executable instructions that when executed perform the inventive steps described herein. The memory 1105 also stores the data associated with or generated by the execution of the inventive steps.

While certain exemplary embodiments and implementations have been described herein, other embodiments and modifications will be apparent from this description. Accordingly, the various embodiments described are not intended to be limiting, but rather are encompassed by the broader scope of the presented claims and various obvious modifications and equivalent arrangements.

What is claimed is:

1. A method comprising:
receiving a data stream containing a plurality of data frames;
determining if a received data frame is of a first type or a second type; and
processing the received data frame based on the determined type,
wherein the type of data frame is selected from a predetermined set of data frame types, and
wherein the determination is based, at least in part, on detecting a first portion of the data frame or a second portion of the data frame.

2. The method of claim 1, wherein the set of data frame types includes at least a very low signal-to-noise ratio (VLSNR) type and a non-VLSNR type.

3. The method of claim 1, wherein the first portion of the data frame includes a first header, and the second portion of the data frame includes a second header, the second header being different from the first header.

4. The method of claim 3, wherein the first header is a physical layer header (PLH) and the second header is a VLSNR header, and wherein the VLSNR header is positioned immediately following the PLH in the data frame.

5. The method of claim 1, wherein the second portion of the data frame is only detected if the signal-to-noise ratio value is lower than a predetermined threshold value.

6. The method of claim 1, further comprising applying at least one error correction technique to the processed data frame for removal of data errors.

7. The method of claim 1, wherein:
the data frame is determined to be the second type; and
the processing further comprises providing an estimated timing indicative of a start of a next data frame.

8. The method of claim 1, further comprising:
detecting a start of a next data frame based on an evaluation of information decoded from the first portion of the data frame; and
detecting the second portion of the data frame.

9. The method of claim 8, wherein the information decoded from the first portion of the data frame is an error correction code rate.

10. The method of claim 1, wherein the processing the received data frame comprises:
demodulating and processing the received data frame as a first type of data frame when it is determined that the received data frame is first type; and
demodulating and processing the received data frame as a second type of data frame when it is determined that the received data frame is a second type.

11. An apparatus comprising:
a tuner that receives a data stream containing a plurality of data frames;
a first processing circuit coupled to the tuner, the first processing circuit processing a data frame from the plurality of data frames if the data frame is determined to be a first type of data frame; and
a second processing circuit coupled to the tuner, the second processing circuit processing the data frame if the data frame is determined to be a second type of data frame,
wherein the type of data frame is selected from a predetermined set of data frame types,
wherein determination that the data frame is the first type is based, at least in part, on detecting a first portion of the data frame, and
wherein determination that the data frame is the second type is based, at least in part, on detecting a second portion of the data frame.

12. The apparatus of claim 11, wherein the set of data frame types includes at least a very low signal-to-noise ratio (VLSNR) type and a non-VLSNR type.

13. The apparatus of claim 11, wherein the first portion of the data frame includes a first header and the second portion of the data frame includes a second header, the second header being different from the first header.

14. The apparatus of claim 13, wherein the first header is a physical layer header (PLH) and the second header is a VLSNR header, where in the VLSNR header is positioned immediately following the PLH in the data frame.

15. The apparatus of claim 11, wherein the second portion of the data frame is only detected if the signal-to-noise ratio value is lower than a predetermined threshold value.

16. The apparatus of claim 11, further including an error correction decoder coupled to the first processing circuit and the second processing circuit, the error correction decoder applying at least one error correction technique to the processed data frame for removal of data errors.

17. The apparatus of claim 11, wherein:
the data frame is determined to the second type of frame; and
the first processing circuit further provides an estimated timing indicative of a start of a next data frame to the second processing circuit.

18. The apparatus of claim 11, wherein at least one of the first processing circuit and second processing circuit further detects a start of a next data frame based on evaluating information decoded from the first portion of the data frame and detecting the second portion of the data frame.

19. The apparatus of claim 11, further comprising:
a second tuner that receives a second data stream containing a plurality of data frames;
a third processing circuit coupled to the second tuner, the third processing circuit processing the data frame if the data frame is determined to be a first type of data frame; and
a fourth processing circuit coupled to the second tuner, the fourth processing circuit processing the data frame if the data frame is determined to be a second type of data frame.

20. The apparatus of claim 19, wherein the data stream received by the tuner and the second data stream received by the second tuner contain the same plurality of data frames.
